(19) United States
(12) Patent Application Publication
(10) Pub. No.: US 2015/0130286 A1
(43) Pub. Date: May 14, 2015

(54) SYSTEMS AND METHODS FOR WIRELESS POWER TRANSMISSION

(71) Applicant: LENOVO (SINGAPORE) PTE. LTD., New Tech Park (SG)

(72) Inventors: Yohichi Kozasu, Yamato-shi (JP); Shigefumi Odaohhara, Yamato-shi (JP); Keiji Suzuki, Fujisawa-shi (JP)

(73) Assignee: LENOVO (SINGAPORE) PTE. LTD., New Tech Park (SG)

(21) Appl. No.: 14/078,248

(22) Filed: Nov. 12, 2013

(51) Int. Cl. H02J 5/00; H01F 38/14; H02J 7/02

(52) U.S. Cl. CPC H02J 5/005; H02J 7/025; H01F 38/14
USPC 307/104

(57) ABSTRACT

Systems and methods are disclosed herein that generally involve wirelessly transmitting power to an electronic device with improved efficiency by reducing or eliminating the Z direction positional gap between the power transmitter and the power receiver and ensuring that the transmitter and receiver electrodes are substantially parallel. In some embodiments, a charging pad fits in the clearance space beneath an electronic device having feet that support the electronic device in an elevated position. In some embodiments, a charging pad includes recesses to accommodate the feet of an electronic device to reduce or eliminate the Z direction positional gap between the electronic device and the charging pad. In some embodiments, a charging pad is biased towards an electronic device by one or more resilient members such that the charging pad conforms to the bottom of the electronic device and such that the Z direction positional gap is reduced or eliminated.

### FIELD

Systems and methods are disclosed herein that generally relate to wireless transmission of power. In some embodiments, such systems and methods are used to wirelessly transmit power for use in charging the battery of an electronic device.

### BACKGROUND

A number of systems have been developed for transmitting power wirelessly, such as those used to charge the battery of an electronic device without having to plug the device into a wall outlet using a typical wired power supply.

Some wireless power transmission systems operate on the principle of inductive coupling, in which power is transmitted from a primary coil of the power transmitting apparatus to a secondary coil of the power receiving apparatus using a magnetic field. An exemplary induction coupling system for charging an electronic device is disclosed in U.S. Pat. No. 8,127,155, entitled “WIRELESS POWER ADAPTER FOR COMPUTER.”

Other wireless power transmission systems operate on the principle of capacitive coupling, in which power is transmitted from a coupling electrode of the power transmitting apparatus to a coupling electrode of the power receiving apparatus through an electric field. An exemplary capacitive coupling system for charging an electronic device is disclosed in European Patent Application Publication No. EP 2,400,633, entitled “POWER TRANSMITTING APPARATUS, POWER RECEIVING APPARATUS, AND WIRELESS POWER TRANSMISSION SYSTEM.”

A need exists for improved systems and methods for wireless power transmission.

### SUMMARY

In some embodiments, a system for wirelessly transmitting power includes a support base, a pad having a transmitter electrode configured to wirelessly transmit power to a receiver electrode via capacitive coupling, and at least one resilient member configured to bias the pad in a direction away from the support base such that, when the system is disposed on a surface and an electronic device is disposed over the pad, the pad is biased towards the electronic device and power can be transmitted wirelessly from the pad to the electronic device.

In some embodiments, a wireless power system includes an electronic device having a receiver electrode, a bottom surface, and a plurality of feet extending from the bottom surface such that the bottom surface is separated from a support surface by a clearance space when the plurality of feet are disposed on the support surface. The system also includes a pad having a transmitter electrode configured to wirelessly transmit power to the receiver electrode of the electronic device via capacitive coupling. The pad is sized to fit within the clearance space.

In some embodiments, a wireless power system includes an electronic device having a receiver electrode, a bottom surface, and a plurality of feet extending from the bottom surface such that the bottom surface is separated from a support surface by a clearance space when the plurality of feet are disposed on the support surface. The system also includes a pad having a transmitter electrode configured to wirelessly transmit power to the receiver electrode of the electronic device via capacitive coupling and at least one recess configured to receive at least one of the plurality of feet of the electronic device such that the bottom surface of the electronic device is in direct contact with a top surface of the pad when the electronic device is disposed on the pad.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1A is a schematic diagram of an exemplary capacitive coupling wireless power transmission system.

FIG. 1B is a plot of power transmission efficiency as a function of positional gap for an exemplary capacitive coupling wireless power transmission system.

FIG. 2A illustrates an exemplary embodiment of a wireless power transmission system and includes a top view of a charging pad and a bottom view of an electronic device.

FIG. 2B is a side view of the pad of FIG. 2A.

FIG. 2C is a side view of the system of FIG. 2A.

FIG. 3A is a side view of another exemplary embodiment of a wireless power transmission system.

FIG. 3B is a top view of an exemplary charging pad that can be used with the system of FIG. 3A.

FIG. 3C is a top view of another exemplary charging pad that can be used with the system of FIG. 3A.

FIG. 3D is a top view of another exemplary charging pad that can be used with the system of FIG. 3A.

FIG. 4A is a side view of another exemplary embodiment of a wireless power transmission system and an exemplary electronic device.

FIG. 4B is a top view of the system of FIG. 4A, with an electronic device shown in phantom.

FIG. 4C is a side view of the system of FIG. 4A with an electronic device disposed over a charging pad of the system.

### DETAILED DESCRIPTION

Systems and methods are disclosed herein that generally involve wirelessly transmitting power to an electronic device with improved efficiency by reducing or eliminating the Z direction positional gap between the power transmitter and the power receiver and ensuring that the transmitter and receiver electrodes are substantially parallel. In some embodiments, a charging pad fits in the clearance space beneath an electronic device having feet that support the electronic device in an elevated position. In some embodiments, a charging pad includes recesses to accommodate the feet of an electronic device to reduce or eliminate the Z direction positional gap between the electronic device and the charging pad. In some embodiments, a charging pad is biased towards an electronic device by one or more resilient members such that the charging pad conforms to the bottom of the electronic device and such that the Z direction positional gap is reduced or eliminated.

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

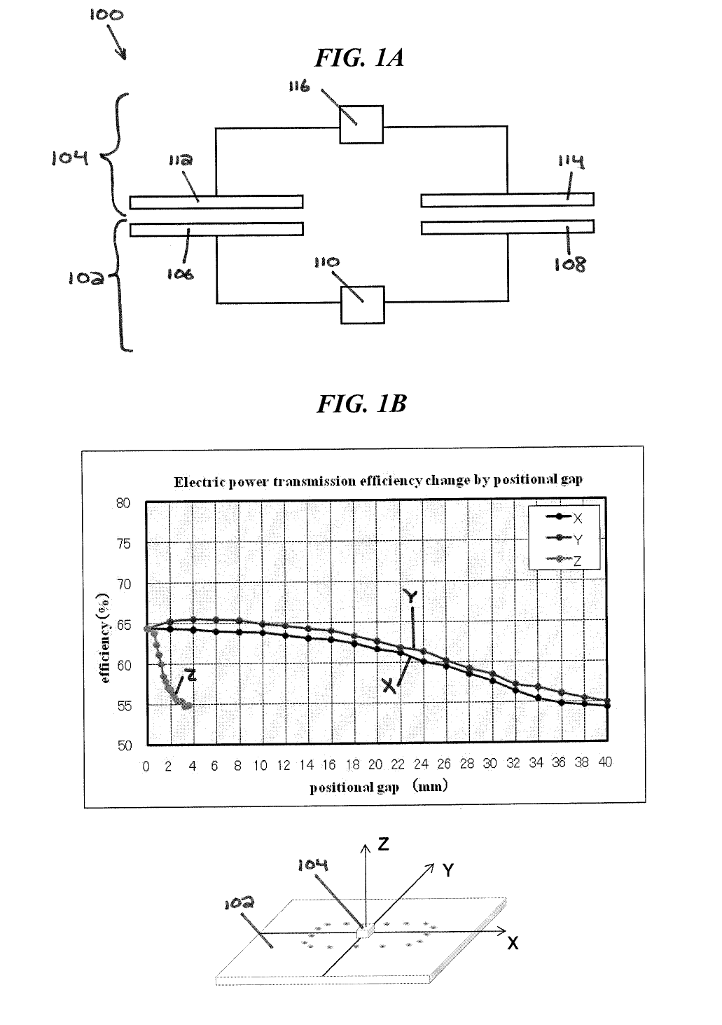

FIG. 1A is a schematic diagram of an exemplary capacitive coupling wireless power transmission system 100. The system includes a power transmitting apparatus 102 and a power receiving apparatus 104. The power transmitting apparatus 102 includes an active electrode 106, a passive electrode 108, and a power transmitting module 110 that includes an inverter and a transformer. The power receiving apparatus 104 includes an active electrode 112, a passive electrode 114, and a power receiving module 116 that includes a transformer and a rectifier. The transmitter-side active electrode 106 and receiver-side active electrode 112 are generally planar and are arranged in proximity to one another in a parallel configuration, effectively forming a parallel plate capacitor in which the electrodes are coupled to one another through an electric field. The transmitter-side passive electrode 108 and the receiver-side passive electrode 114 are similarly arranged.

In operation, the power transmitting module 110 receives a DC input, for example from a standard laptop computer power supply. The DC input is converted to AC using the inverter and then stepped up in voltage using the transmitter-side transformer. The stepped-up AC signal is coupled to the power receiving module 116 via the active electrodes 106, 112 and the passive electrodes 108, 114. The received AC signal is then stepped down in voltage using the receiver-side transformer and converted to a DC output using the rectifier. The DC output can be used to supply power to a load connected to the power receiving module 116, such as the battery of an electronic device.

The efficiency with which the system of FIG. 1A can wirelessly transmit power is dependent upon the relative position of the power transmitting apparatus 102 and the power receiving apparatus 104. As shown in FIG. 1B, efficiency decreases at a considerable rate as the power transmitting apparatus 102 is moved away from the power receiving apparatus 104 in the Z direction. As the power transmitting apparatus 102 is shifted in the X or Y directions relative to the power receiving apparatus 104, the efficiency also decreases but at a much lower rate. It can thus be desirable to maintain as little a position gap as possible between the power transmitting apparatus 102 and the power receiving apparatus 104 in the Z direction so as to maximize the efficiency with which power can be wirelessly transferred. In addition, power transmission efficiency decreases when the active electrodes 106, 112 are not parallel to one another and/or when the passive electrodes 108, 114 are not parallel to one another. Accordingly, it can be desirable to ensure that the electrodes are as close to parallel as possible to maximize the efficiency with which power can be wirelessly transferred.

In many instances, the power receiving apparatus 104 can have structural features that lead to increased Z direction positional gap or non-parallel electrode positioning. For example, many laptop computers include feet extending from the bottom surface of the laptop. The feet cause the laptop computer to be supported in an elevated position, increasing the Z direction positional gap when the laptop is placed on a power transmitting apparatus. When the laptop includes feet with different heights, the laptop is supported in a non-parallel position relative to the power transmitting apparatus. In some embodiments, the systems and methods disclosed herein address these and other concerns.

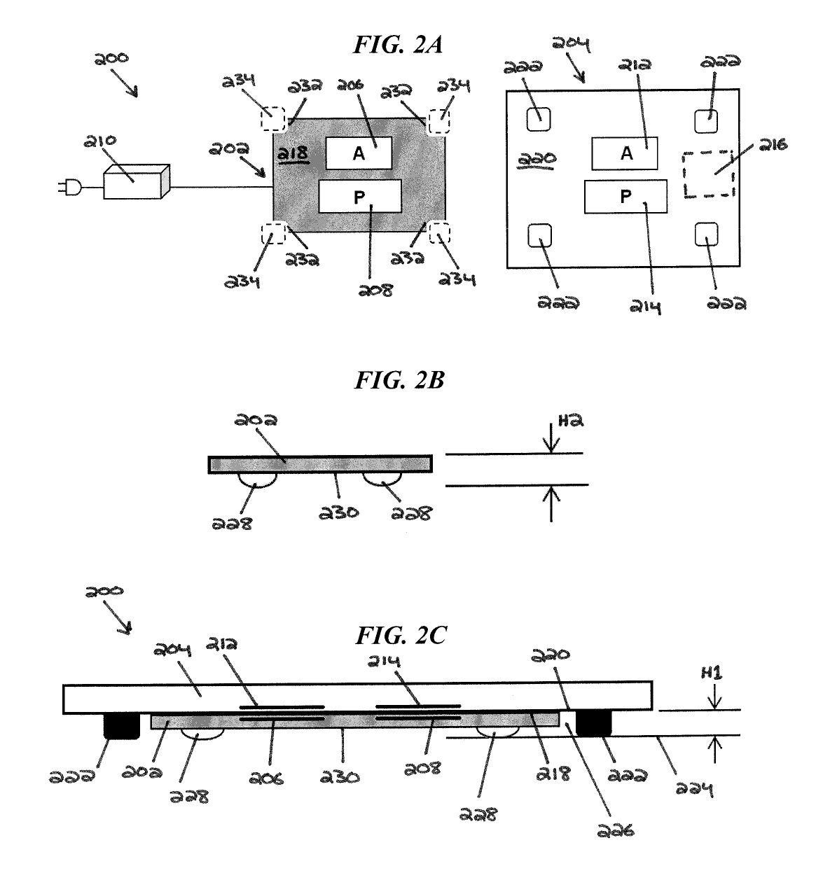

FIGS. 2A-2C illustrate an exemplary embodiment of a capacitive coupling wireless power system 200 in which the positional gap in the Z direction between a power transmitting apparatus (e.g., a charging pad 202) and a power receiving apparatus (e.g., an electronic device 204) is reduced or eliminated.

The charging pad 202 includes at least one transmitter electrode configured to wirelessly transmit power to a receiver electrode in the electronic device 204 via capacitive coupling. In the illustrated embodiment, the charging pad 202 includes an active electrode 206 and a passive electrode 208, although more or less than two electrodes can be provided in other embodiments. The illustrated electrodes 206, 208 are planar and generally rectangular, however any of a variety of electrode shapes and configurations can be used. The electrodes 206, 208 are formed on or just below a top surface 218 of the pad 202, such that the electrodes are as close as possible to the electronic device 204 when the electronic device is disposed over the pad. The charging pad 202 also includes a power transmitting module 210 that includes an inverter and a transformer. While the illustrated pad 202 is generally plus-shaped, the pad can have a variety of other shapes such as rectangular, square, circular, elliptical, etc.

In the illustrated embodiment, the electronic device 204 is a laptop computer, however any of a variety of electronic devices can be used, such as tablet computers, mobile phones, digital cameras, portable music players, any portable device with a rechargeable battery, etc. The electronic device 204 includes at least one receiver electrode configured to wirelessly receive power transmitted from the electrode(s) 206, 208 of the charging pad 202 via capacitive coupling. In the illustrated embodiment, the electronic device 204 includes an active electrode 212 and a passive electrode 214, although more or less than two electrodes can be provided in other embodiments. The illustrated electrodes 212, 214 are planar and generally rectangular, however any of a variety of electrode shapes and configurations can be used. The electrodes 212, 214 are sized and shaped to correspond to the size and shape of the electrodes 206, 208 in the charging pad 202. In particular, the electrodes 212, 214 in the electronic device 204 have a size and shape that mirrors those of the respective electrodes 206, 208 in the charging pad 202, such that the active electrodes 206, 212 are aligned and the passive electrodes 208, 214 are aligned when the electronic device 204 is disposed over the charging pad 202. The electrodes 212, 214 are formed on or just above a bottom surface 220 of the electronic device 204, such that the electrodes are as close as possible to the pad 202 when the electronic device is disposed over the pad. The electronic device 204 also includes a power receiving module 216 that includes a transformer and a rectifier.

The electronic device 204 includes a plurality of feet 222 that extend from the bottom surface 220 of the electronic device 204. While four feet 222 are shown, it will be appreciated that the electronic device 204 can include any number of feet, which can be arranged in a rectangular pattern as shown or in any other pattern or arrangement. The feet 222 are configured to support the electronic device 204 in an elevated position above a support surface 224 on which the electronic device is disposed (e.g., a table or desk surface), such that a clearance space 226 is defined between the support surface and the bottom surface 220 of the electronic device. The illustrated clearance space 226 has a height H1.

The pad 202 is sized to fit within the clearance space 226 defined between the support surface 224 and the bottom surface 220 of the electronic device 204. In particular, the pad 202 has a height H2 that is less than or equal to the height H1 of the clearance space 226. Accordingly, when the electronic device 204 is disposed over the charging pad 202, the top surface 218 of the pad can be in direct contact with the bottom surface 220 of the electronic device, or can be separated from the bottom surface of the electronic device by a small distance in the Z direction (e.g., less than about 5 mm, less than about 2 mm, less than about 1 mm, less than about 0.5 mm, less than about 0.25 mm, etc.).

The pad 202 can be configured to lie directly on the support surface 224, in which case the pad height H2 is defined by the thickness of the pad. In other embodiments, the pad 202 can include one or more pad feet 228, in which case the pad height H2 is defined by the combination of the pad thickness and the height of the pad feet. The pad feet 228 can be adjustable, such that the pad height H2 can be selectively increased or decreased depending on the size of the clearance space 226 to reduce the spacing between the electrodes in the Z direction. In some embodiments, the pad feet 228 can be threaded into or otherwise adjustably coupled to the bottom surface 230 of the pad 202, and can be rotated or otherwise moved manually or automatically (e.g., via a motor or actuator system) to adjust the pad height H2.

The pad 202 can have a perimeter that fits within a perimeter defined by the plurality of feet 222 of the electronic device 204. For example, in the case of a rectangular pad and rectangular arrangement of feet on the electronic device, the pad can have a width that is less than the clearance width between adjacent feet and/or a length that is less than the clearance length between adjacent feet.

The pad 202 can also have a perimeter that extends beyond a perimeter defined by the plurality of feet 222 of the electronic device 204. To that end, the pad can have one or more cut out portions 232 formed therein to accommodate the feet 222 of the electronic device 204. In particular, the pad 202 can include a plurality of cut out portions 232 sized and positioned to receive the feet 222 of the electronic device 204 when the pad is disposed in the clearance space 226 between the electronic device and the support surface 224. In some embodiments, the cut out portions 232 are formed in the corners of the pad, such that the pad is circular, elliptical, plus-shaped as shown in FIG. 2A, etc. In the embodiment of FIG. 2A, the pad 202 and the cut-out portions 232 are sized and positioned to receive the feet 222 of the electronic device 204, as shown by the dashed lines 234 which represent the footprint of the electronic device.

As shown in FIG. 2C, when the electronic device 204 is disposed over the charging pad 202, the electrodes 206, 208 in the charging pad are placed in close proximity to the electrodes 212, 214 in the electronic device in the Z direction, as well as in the X and Y directions. Accordingly, power can be efficiently transmitted to the electronic device 204 via wireless capacitive coupling. Specifically, the power transmitting module 210 of the charging pad 202 receives a DC input, for example from a standard laptop computer power supply. The DC input is converted to AC using an inverter and then stepped up in voltage using a transformer. The stepped-up AC signal is coupled to the electronic device 204 via the active electrodes 206, 212 and the passive electrodes 208, 214. The received AC signal is then stepped down in voltage using a receiver-side transformer in the power receiving module 216 of the electronic device 204 and converted to a DC output using a rectifier. The DC output can be used to supply power to a load, such as a rechargeable battery of the electronic device 204.

The charging pad 202 can be formed from any of a variety of materials, including plastic, rubber, polymers, combinations thereof, and so forth. The electrodes 206, 208, 212, 214 can be formed from an electrically-conductive material, such as copper, silver, gold, combinations thereof, and so forth.

It will be appreciated that the system 200 can be used with a variety of electronic devices (e.g., devices having different sizes, types, foot configurations, foot heights, device models, etc.) without requiring that the electronic device or the pad be customized or specifically-tailored. For example, the pad 202 can be made small enough to fit within the clearance space of many different types or models of laptop computers, and/or can have multiple sets of cut outs where each set corresponds to a different type or model of laptop computer. The pad 202 can also have adjustable pad feet 228 as described above.

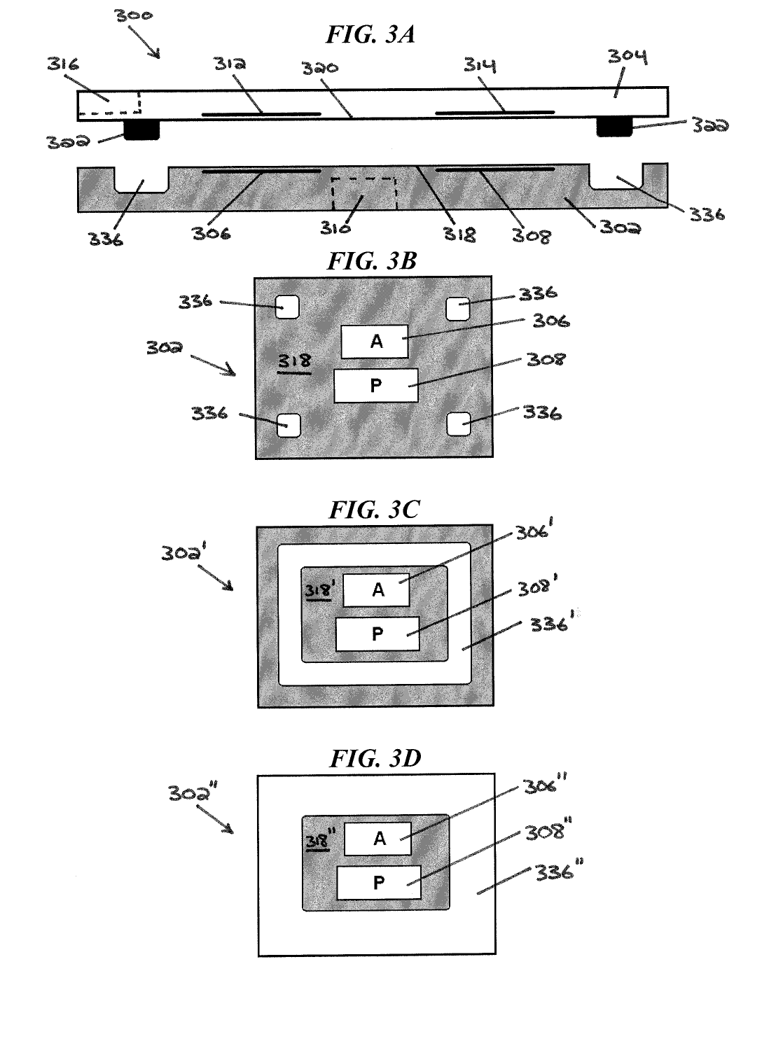

FIGS. 3A-3D illustrate another exemplary embodiment of a capacitive coupling wireless power system 300 in which the positional gap in the Z direction between a power transmitting apparatus (e.g., a charging pad 302) and a power receiving apparatus (e.g., an electronic device 304) is reduced or eliminated.

The charging pad 302 includes at least one transmitter electrode configured to wirelessly transmit power to a receiver electrode in the electronic device 304 via capacitive coupling. In the illustrated embodiment, the charging pad 302 includes an active electrode 306 and a passive electrode 308, although more or less than two electrodes can be provided in other embodiments. The illustrated electrodes 306, 308 are planar and generally rectangular, however any of a variety of electrode shapes and configurations can be used. The electrodes 306, 308 are formed on or just below a top surface 318 of the pad 302, such that the electrodes are as close as possible to the electronic device 304 when the electronic device is disposed over the pad. The charging pad 302 also includes a power transmitting module 310 that includes an inverter and a transformer. The pad can have a variety of shapes such as rectangular, square, circular, elliptical, etc.

In the illustrated embodiment, the electronic device 304 is a laptop computer, however any of a variety of electronic devices can be used, such as tablet computers, mobile phones, digital cameras, portable music players, any portable device with a rechargeable battery, etc. The electronic device 304 includes at least one receiver electrode configured to wirelessly receive power transmitted from the electrode(s) 306, 308 of the charging pad 302 via capacitive coupling. In the illustrated embodiment, the electronic device 304 includes an active electrode 312 and a passive electrode 314, although more or less than two electrodes can be provided in other embodiments. The illustrated electrodes 312, 314 are planar and generally rectangular, however any of a variety of electrode shapes and configurations can be used. The electrodes 312, 314 are sized and shaped to correspond to the size and shape of the electrodes 306, 308 in the charging pad 302. In particular, the electrodes 312, 314 in the electronic device 304 have a size and shape that mirrors those of the respective electrodes 306, 308 in the charging pad 302, such that the active electrodes 306, 312 are aligned and the passive electrodes 308, 314 are aligned when the electronic device 304 is disposed over the charging pad 302. The electrodes 312, 314 are formed on or just above a bottom surface 320 of the electronic device 304, such that the electrodes are as close as possible to the pad 302 when the electronic device is disposed over the pad. The electronic device 304 also includes a power receiving module 316 that includes a transformer and a rectifier.

The electronic device 304 includes a plurality of feet 322 that extend from the bottom surface 320 of the electronic device 304. While four feet 322 are included in the illustrated embodiment, it will be appreciated that the electronic device 304 can include any number of feet, which can be arranged in a rectangular pattern as shown or in any other pattern or arrangement. When the electronic device 304 is not disposed over the charging pad 302, the feet 322 are configured to support the electronic device 304 in an elevated position above a support surface on which the electronic device is disposed (e.g., a table or desk surface).

When the electronic device 304 is disposed over the pad 302, however, the feet 322 are received in one or more recesses 336 formed in the pad. The recesses 336 can have a depth that is equal to or greater than the height of the feet 322. Accordingly, when the electronic device 304 is disposed over the charging pad 302, the top surface 318 of the pad can be in direct contact with the bottom surface 320 of the electronic device. Alternatively, the recesses 336 can have a shallower depth such that the top surface 318 of the pad 302 can be separated from the bottom surface 320 of the electronic device 304 by a small distance in the Z direction (e.g., less than about 5 mm, less than about 2 mm, less than about 1 mm, less than about 0.5 mm, less than about 0.25 mm, etc.). The recesses 336 can be blind openings formed in the pad 302 as shown, or can extend all the way through the thickness of the pad.

In FIGS. 3A and 3B, the pad 302 includes four recesses 336 which are formed at the corners of a rectangular pattern. The four recesses 336 are disposed in positions corresponding to the location of the feet 322 of the electronic device 304. The electrodes 306, 308 are positioned relative to the recesses 336 in a manner that corresponds to the positioning of the electrodes 312, 314 relative to the feet 322 of the electronic device 304. Accordingly, when the feet 322 of the electronic device 304 are aligned with the recesses 336 of the pad 302, the active electrodes 306, 312 are aligned with one another and the passive electrodes 308, 314 are aligned with one another.

FIG. 3C illustrates an alternative embodiment of the pad 302′ in which the at least one recess includes a trough 336′ that extends along a rectangular path. While a rectangular path is shown, it will be appreciated that the trough 336′ can extend along any path that corresponds with the path along which the feet 322 of the electronic device 304 are disposed. The trough 336′ can allow the pad 302′ to be used with a broader set of electronic devices than embodiments with a plurality of discrete recesses, and can allow a greater degree of X and Y displacement of the electronic device relative to the pad.

FIG. 3D illustrates an alternative embodiment of the pad 302″ in which the at least one recess includes a depressed perimeter portion 336″. In other words, the pad 302″ has a perimeter portion with a thickness in the Z direction that is less than that of the central portion of the pad where the electrodes 306″, 308″ are positioned. The depressed perimeter portion 336″ can allow the pad 302″ to be used with a broader set of electronic devices than embodiments with a plurality of discrete recesses or with a trough-shaped recess, and can allow a greater degree of X and Y displacement of the electronic device relative to the pad.

When the electronic device 304 is disposed over the charging pad 302, the electrodes 306, 308 in the charging pad are placed in close proximity to the electrodes 312, 314 in the electronic device in the Z direction, as well as in the X and Y directions. Accordingly, power can be efficiently transmitted to the electronic device 304 via wireless capacitive coupling. Specifically, the power transmitting module 310 of the charging pad 302 receives a DC input, for example from a standard laptop computer power supply. The DC input is converted to AC using an inverter and then stepped up in voltage using a transformer. The stepped-up AC signal is coupled to the electronic device 304 via the active electrodes 306, 312 and the passive electrodes 308, 314. The received AC signal is then stepped down in voltage using a receiver-side transformer in the power receiving module 316 of the electronic device 304 and converted to a DC output using a rectifier. The DC output can be used to supply power to a load, such as a rechargeable battery of the electronic device 304.

The charging pad 302 can be formed from any of a variety of materials, including plastic, rubber, polymers, combinations thereof, and so forth. The electrodes 306, 308, 312, 314 can be formed from an electrically-conductive material, such as copper, silver, gold, combinations thereof, and so forth.

It will be appreciated that the system 300 can be used with a variety of electronic devices (e.g., devices having different sizes, types, foot configurations, foot heights, device models, etc.) without requiring that the electronic device or the pad be customized or specifically-tailored. For example, the recesses in the pad can be made large enough and/or deep enough to accommodate the feet of many different types or models of laptop computers. The pad can also have multiple sets of recesses where each set corresponds to a different type or model of laptop computer.

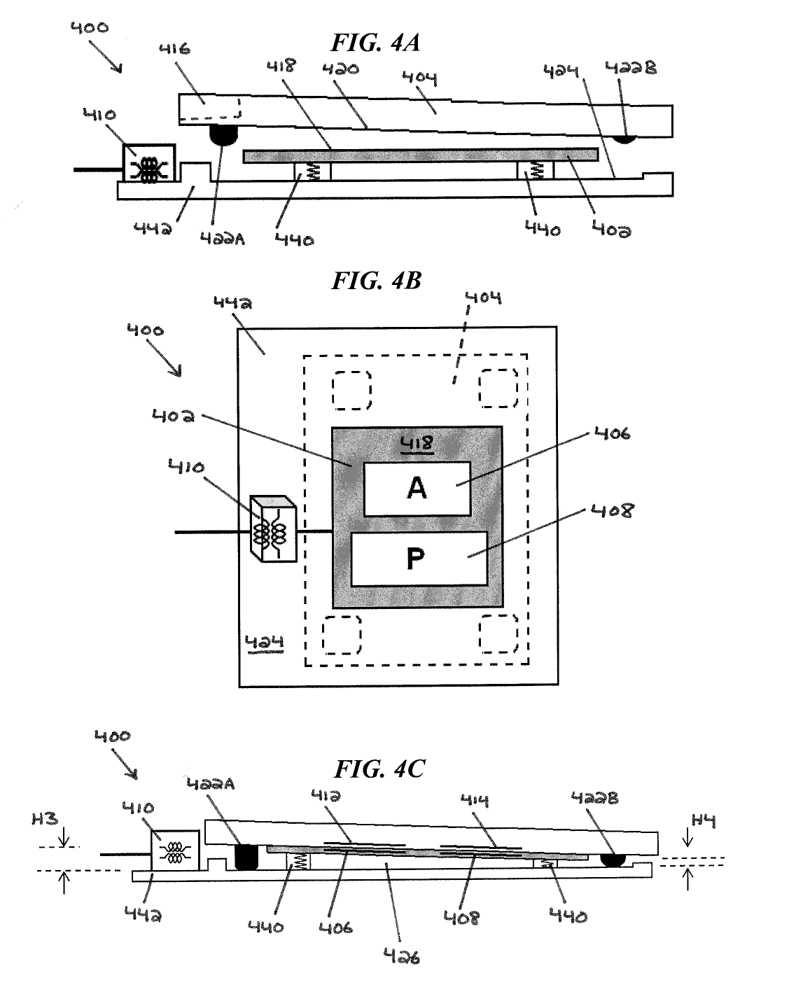

FIGS. 4A-4C illustrate another exemplary embodiment of a capacitive coupling wireless power system 400 in which the positional gap in the Z direction between a power transmitting apparatus (e.g., a charging pad 402) and a power receiving apparatus (e.g., an electronic device 404) is reduced or eliminated.

The charging pad 402 includes at least one transmitter electrode configured to wirelessly transmit power to a receiver electrode in the electronic device 404 via capacitive coupling. In the illustrated embodiment, the charging pad 402 includes an active electrode 406 and a passive electrode 408, although more or less than two electrodes can be provided in other embodiments. The illustrated electrodes 406, 408 are planar and generally rectangular, however any of a variety of electrode shapes and configurations can be used. The electrodes 406, 408 are formed on or just below a top surface 418 of the pad 402, such that the electrodes are as close as possible to the electronic device 404 when the electronic device is disposed over the pad. The charging pad 402 also includes a power transmitting module 410 that includes an inverter and a transformer. While the illustrated pad 402 is generally rectangular, the pad can have a variety of other shapes such as square, circular, elliptical, etc.

In the illustrated embodiment, the electronic device 404 is a laptop computer, however any of a variety of electronic devices can be used, such as tablet computers, mobile phones, digital cameras, portable music players, any portable device with a rechargeable battery, etc. The electronic device 404 includes at least one receiver electrode configured to wirelessly receive power transmitted from the electrode(s) 406, 408 of the charging pad 402 via capacitive coupling. In the illustrated embodiment, the electronic device 404 includes an active electrode 412 and a passive electrode 414, although more or less than two electrodes can be provided in other embodiments. The illustrated electrodes 412, 414 are planar and generally rectangular, however any of a variety of electrode shapes and configurations can be used. The electrodes 412, 414 are sized and shaped to correspond to the size and shape of the electrodes 406, 408 in the charging pad 402. In particular, the electrodes 412, 414 in the electronic device 404 have a size and shape that mirrors those of the respective electrodes 406, 408 in the charging pad 402, such that the active electrodes 406, 412 are aligned and the passive electrodes 408, 414 are aligned when the electronic device 404 is disposed over the charging pad 402. The electrodes 412, 414 are formed on or just above a bottom surface 420 of the electronic device 404, such that the electrodes are as close as possible to the pad 402 when the electronic device is disposed over the pad. The electronic device 404 also includes a power receiving module 416 that includes a transformer and a rectifier.

The electronic device 404 includes a plurality of feet 422A, 422B that extend from the bottom surface 420 of the electronic device 404. While two feet are shown, it will be appreciated that the illustrated electronic device 404 includes four feet, with one foot at each corner of the electronic device. It will also be appreciated that the electronic device 404 can include any number of feet, which can be arranged in a rectangular pattern as shown or in any other pattern or arrangement. The feet 422A, 422B are configured to support the electronic device 404 in an elevated position above a support surface 424 on which the electronic device is disposed (e.g., a table or desk surface), such that a clearance space 426 is defined between the support surface and the bottom surface 420 of the electronic device. As shown in FIG. 4C, the clearance space 426 can have a non-uniform height, for example when the feet 422A supporting the back of the electronic device 404 have a height H3 that is greater than the height H4 of the feet 422B supporting the front of the electronic device. In the case of an exemplary laptop computer, the back feet can have a height H3 of about 3.5 mm and the front feet can have a height of about 1 mm.

The pad 402 is sized to fit within the clearance space 426 defined between the support surface 424 and the bottom surface 420 of the electronic device 404. In particular, the pad 402 has a height that is less than or equal to the minimum height of the clearance space 426. In addition, the system 400 includes at least one resilient member 440 configured to bias the pad 402 in a direction away from the support surface 424, towards the electronic device 404. In the illustrated embodiment, the support surface 424 is defined by a support base 442 on which the power transmitting module 410 is mounted, and the pad 402 is coupled to the support base 442 by the resilient member(s) 440. In other embodiments, the support base 442 can be omitted, in which case the resilient member(s) 440 can be coupled to the pad 402 and can be configured to sit directly on some other support surface, such as the top of a desk or table. In such embodiments, the power transmitting module 410 can be mounted in or on the pad 402.

The resilient member(s) 440 are configured to bias the pad 402 towards the electronic device 404. Accordingly, when the electronic device 404 is disposed over the charging pad 402, the top surface 418 of the pad can be in direct contact with the bottom surface 420 of the electronic device, or can be separated from the bottom surface of the electronic device by a small distance in the Z direction (e.g., less than about 5 mm, less than about 2 mm, less than about 1 mm, less than about 0.5 mm, less than about 0.25 mm, etc.). In addition, the resilient member(s) 440 allow the pad 402 to have a non-uniform height, such that the pad can conform to the non-uniform clearance space and ensure that the electrodes 406, 408 in the pad 402 are parallel or very close to parallel with the electrodes 412, 414 in the electronic device 404. The pad 402 can thus act as a floating plate supported by the resilient member(s) 440 to conform to the bottom surface of any of a variety of electronic devices.

The resilient member(s) 440 can be any structure or element configured to bias the pad 402 towards the electronic device 404. In some embodiments, the resilient member(s) 440 are four coil springs disposed at the four corners of the pad 402. It will be appreciated that other types of springs can be used, including leaf springs, and that any number of springs can be used, including one, two, three, or more than four. In some embodiments, the resilient member(s) 440 include one or more pieces of a compressible and resilient material disposed beneath the pad 402. Exemplary materials include open and closed-cell foams, sponges, polyurethane foam, polystyrene, rubber, and so forth. In some embodiments, the resilient member(s) 440 include one or more inflatable containers. For example, the resilient member(s) 440 can include a fluid or gas filled dome or balloon attached to the bottom surface of the pad 402.

The pad 402 can have a perimeter that fits within a perimeter defined by the plurality of feet 422A, 422B of the electronic device 404. For example, in the case of a rectangular pad and rectangular arrangement of feet on the electronic device, the pad can have a width that is less than the clearance width between adjacent feet and/or a length that is less than the clearance length between adjacent feet.

The pad 402 can also have a perimeter that extends beyond a perimeter defined by the plurality of feet 422A, 422B of the electronic device 404. To that end, the pad can have one or more cut out portions formed therein to accommodate the feet of the electronic device 404. In particular, the pad 402 can include a plurality of cut out portions sized and positioned to receive the feet 422A, 422B of the electronic device 404 when the pad is disposed in the clearance space 426 between the electronic device and the support surface 424. In some embodiments, the cut out portions are formed in the corners of the pad, such that the pad is circular, elliptical, plus-shaped, etc.

As shown in FIG. 4C, when the electronic device 404 is disposed over the charging pad 402, the electrodes 406, 408 in the charging pad are placed in close proximity to the electrodes 412, 414 in the electronic device in the Z direction, as well as in the X and Y directions. They are also positioned in a parallel or substantially parallel relationship. Accordingly, power can be efficiently transmitted to the electronic device 404 via wireless capacitive coupling. Specifically, the power transmitting module 410 of the charging pad 402 receives a DC input, for example from a standard laptop computer power supply. The DC input is converted to AC using an inverter and then stepped up in voltage using a transformer. The stepped-up AC signal is coupled to the electronic device 404 via the active electrodes 406, 412 and the passive electrodes 408, 414. The received AC signal is then stepped down in voltage using a receiver-side transformer in the power receiving module 416 of the electronic device 404 and converted to a DC output using a rectifier. The DC output can be used to supply power to a load, such as a rechargeable battery of the electronic device 404.

The charging pad 402 and the support base 442 can be formed from any of a variety of materials, including plastic, rubber, polymers, combinations thereof, and so forth. The electrodes 406, 408, 412, 414 can be formed from an electrically-conductive material, such as copper, silver, gold, combinations thereof, and so forth. In an exemplary embodiment, the pad 402 can be about 170 mm wide, about 170 mm long, and less than about 1 mm thick.

It will be appreciated that the system 400 can be used with a variety of electronic devices (e.g., devices having different sizes, types, foot configurations, foot heights, device models, etc.) without requiring that the electronic device or the pad be customized or specifically-tailored. For example, the pad 402 can be made small enough to fit within the clearance space of many different types or models of laptop computers, and the floating/biased nature of the pad can allow it to conform to the bottom surface of many different types or models of laptop computers. The pad can also have multiple sets of cut outs where each set corresponds to different type or model of laptop computer.

The electrical configuration of the power transmitting modules and power receiving modules disclosed herein is merely exemplary, and any of a variety of alternative schemes can be used instead or in addition. For example, in some embodiments the inverter can be omitted and the power transmitting module can be supplied directly with AC power from a standard wall outlet. In addition, while wireless power systems that use capacitive coupling are generally described above, it will be appreciated that the systems and methods disclosed herein can use other wireless power transfer schemes instead or in addition, including inductive coupling schemes.

Although the invention has been described by reference to specific embodiments, it should be understood that numerous changes may be made within the spirit and scope of the inventive concepts described.

Accordingly, it is intended that the invention not be limited to the described embodiments, but that it have the full scope defined by the language of the following claims.

What is claimed is:

1. A system for wirelessly transmitting power, comprising:
a support base;
a pad having a transmitter electrode configured to wirelessly transmit power to a receiver electrode via capacitive coupling; and
at least one resilient member configured to bias the pad in a direction away from the support base such that, when the system is disposed on a surface and an electronic device is disposed over the pad, the pad is biased towards the electronic device and power can be transmitted wirelessly from the pad to the electronic device.

2. The system of claim 1, wherein the at least one resilient member is disposed between the base and the pad.

3. The system of claim 1, wherein the at least one resilient member is configured to bias the pad into direct contact with a bottom surface of an electronic device when the system is disposed on a surface and an electronic device is disposed over the pad.

4. The system of claim 1, wherein the transmitter electrode comprises an active electrode and a passive electrode.

5. The system of claim 1, wherein the at least one resilient member comprises a spring.

6. The system of claim 5, wherein the spring comprises a coil spring or a leaf spring.

7. The system of claim 1, wherein the at least one resilient member comprises a foam layer or a sponge layer.

8. The system of claim 1, wherein the at least one resilient member comprises an inflatable member.

9. The system of claim 1, wherein the at least one resilient member allows the pad to have a non-uniform height.

10. A wireless power system, comprising:
an electronic device having a receiver electrode, a bottom surface, and a plurality of feet extending from the bottom surface such that the bottom surface is separated from a support surface by a clearance space when the plurality of feet are disposed on the support surface; and
a pad having a transmitter electrode configured to wirelessly transmit power to the receiver electrode of the electronic device via capacitive coupling;
wherein the pad is sized to fit within the clearance space.

11. The system of claim 10, wherein the pad is sized to fit within the clearance space such that an upper surface of the pad is in direct contact with the bottom surface of the electronic device.

12. The system of claim 10, wherein the pad has a height that is equal to a height of the clearance space.

13. The system of claim 10, wherein the pad has a plurality of pad feet extending from a bottom surface thereof, and wherein the pad and the pad feet have a combined height that is equal to a height of the clearance space.

14. The system of claim 10, wherein the pad has a perimeter that fits within a perimeter defined by the plurality of feet of the electronic device.

15. The system of claim 10, wherein the pad comprises a plurality of cut out portions sized and positioned to receive the feet of the electronic device when the pad is disposed in the clearance space.

16. The system of claim 15, wherein the cut out portions are formed in the corners of the pad.

17. A wireless power system, comprising:
an electronic device having a receiver electrode, a bottom surface, and a plurality of feet extending from the bottom surface such that the bottom surface is separated from a support surface by a clearance space when the plurality of feet are disposed on the support surface; and
a pad having a transmitter electrode configured to wirelessly transmit power to the receiver electrode of the electronic device via capacitive coupling and at least one recess configured to receive at least one of the plurality of feet of the electronic device such that the bottom surface of the electronic device is in direct contact with a top surface of the pad when the electronic device is disposed on the pad.

18. The system of claim 17, wherein the at least one recess comprises four recesses formed at the corners of a rectangular pattern.

19. The system of claim 17, wherein the at least one recess comprises a trough that extends along a rectangular path.

20. The system of claim 17, wherein the at least one recess comprises a depressed perimeter portion of the pad.

21. The system of claim 17, wherein at least one recess has a depth that is equal to or greater than a height of the plurality of feet.

22. The system of claim 17, wherein at least one recess comprises multiple sets of recesses, wherein each set of recesses corresponds to a different type of electronic device.
